(19) United States
(12) Patent Application Publication
(10) Pub. No.: US 2020/0293911 A1
(43) Pub. Date: Sep. 17, 2020

(54) PERFORMING DATA PROCESSING BASED ON DECISION TREE

(71) Applicant: Alibaba Group Holding Limited, George Town (KY)

(72) Inventors: Lichun Li, Hangzhou (CN); Jinsheng Zhang, Hangzhou (CN); Huazhong Wang, Hangzhou (CN)

(73) Assignee: Alibaba Group Holding Limited, George Town (KY)

(21) Appl. No.: 16/890,626

(22) Filed: Jun. 2, 2020

Related U.S. Application Data
(63) Continuation of application No. 16/779,250, filed on Jan. 31, 2020.
Application No. 16/779,250 is a continuation of application No. PCT/CN2020/071438, filed on Jan. 10, 2020.

(30) Foreign Application Priority Data
Jul. 1, 2019 (CN) 201910583566.4

(51) Int. Cl. G06N 5/02; G06F 7/58

(52) U.S. Cl. CPC G06N 5/02; G06F 7/588

(57) ABSTRACT

Disclosed herein are methods, systems, and apparatus, including computer programs encoded on computer storage media, for data processing. One of the methods includes: determining target location identifiers identifying leaf nodes of a decision tree in a decision forest based on parameter information of the decision tree; performing oblivious transfer with a second computing device by using the target location identifiers as input; and selecting a target cyphertext from cyphertexts of leaf values corresponding to leaf nodes of the decision tree, wherein the cyphertexts are generated by encrypting the leaf values based on a random number and are used by the second computing device to perform the oblivious transfer.

### CROSS-REFERENCE TO RELATED APPLICATIONS

This application is a continuation of and claims the benefit of U.S. patent application Ser. No. 16/779,250, filed Jan. 31, 2020, which is a continuation of and claims the benefit of priority of PCT Application No. PCT/CN2020/071438, filed on Jan. 10, 2020, which claims priority to Chinese Patent Application No. 201910583566.4, filed on Jul. 1, 2019, and each application is hereby incorporated by reference in its entirety.

### TECHNICAL FIELD

Implementations of the present specification relate to the field of computer technologies, and in particular, to a data processing method and device, and an electronic device.

### BACKGROUND

During service implementation, generally, one party usually has a model that needs to be kept secret (hereafter referred to as a model owner), and the other party has service data that needs to be kept secret (hereafter referred to as a data owner). A technical problem that needs to be urgently resolved is to enable the model owner and/or the data owner to obtain a prediction result obtained by predicting service data based on a model while the model owner does not disclose the model and the data owner does not disclose the service data.

### SUMMARY

An object of implementations of the present specification is to provide a data processing method and device, and an electronic device, so that a first device and/or a second device obtain/obtains a prediction result obtained by predicting service data based on an original decision forest while the first device does not disclose the original decision forest and the second device does not disclose the service data.

To achieve the previous object, one or more implementations of the present specification provide the following technical solutions:

According to a first aspect of one or more implementations of the present specification, a data processing method is provided, applied to a first device, where the first device provides a decision forest, and the decision forest includes at least one decision tree; and the method includes: sending parameter information of the decision tree to a second device, where the parameter information includes a location identifier corresponding to a burst node, a splitting criterion corresponding to the burst node, and a location identifier corresponding to each leaf node, but does not include a leaf value corresponding to each leaf node.

According to a second aspect of one or more implementations of the present specification, a data processing device is provided, applied to a first device, where the first device provides a decision forest, and the decision forest includes at least one decision tree; and the device includes: a sending unit, configured to send parameter information of the decision tree to a second device, where the parameter information includes a location identifier corresponding to a burst node, a splitting criterion corresponding to the burst node, and a location identifier corresponding to each leaf node, but does not include a leaf value corresponding to each leaf node.

According to a third aspect of one or more implementations of the present specification, an electronic device is provided, including: a memory, configured to store computer instructions; and a processor, configured to execute the computer instructions to implement method steps according to the first aspect.

According to a fourth aspect of one or more implementations of the present specification, a data processing method is provided, applied to a first device, where the first device provides a decision forest, and the decision forest includes at least one decision tree; and the method includes: generating a random number corresponding to the decision tree; encrypting leaf values corresponding to leaf nodes in the decision tree by using the random number, to obtain leaf value ciphertexts; and performing oblivious transfer with a second device by using the leaf values corresponding to the leaf nodes in the decision tree as an input.

According to a fifth aspect of one or more implementations of the present specification, a data processing device is provided, applied to a first device, where the first device provides a decision forest, and the decision forest includes at least one decision tree; and the device includes: a generation unit, configured to generate a random number corresponding to the decision tree; an encryption unit, configured to encrypt leaf values corresponding to leaf nodes in the decision tree by using the random number, to obtain leaf value ciphertexts; and a transfer unit, configured to perform oblivious transfer with a second device by using the leaf values corresponding to the leaf nodes in the decision tree as an input.

According to a sixth aspect of one or more implementations of the present specification, an electronic device is provided, including: a memory, configured to store computer instructions; and a processor, configured to execute the computer instructions to implement method steps according to the fourth aspect.

According to a seventh aspect of one or more implementations of the present specification, a data processing method is provided, applied to a second device, where the second device provides parameter information of a decision tree in a decision forest; the parameter information includes a location identifier corresponding to a burst node, a splitting criterion corresponding to the burst node, and a location identifier corresponding to each leaf node, but does not include a leaf value corresponding to each leaf node; and the method includes: determining a target location identifier based on the parameter information of the decision tree in a decision forest, where a leaf node corresponding to the target location identifier matches service data; performing oblivious transfer with a first device by using the target location identifier as an input; and selecting a target leaf value ciphertext from leaf value ciphertexts that correspond to leaf nodes in the decision tree in the decision forest and that are input by the first device, where the leaf value ciphertexts corresponding to the leaf nodes are obtained by encrypting the leaf values corresponding to the leaf nodes with a random number.

According to an eighth aspect of one or more implementations of the present specification, a data processing device is provided, applied to a second device, where the second device provides parameter information of a decision tree in a decision forest; the parameter information includes a location identifier corresponding to a burst node, a splitting criterion corresponding to the burst node, and a location identifier corresponding to each leaf node, but does not include a leaf value corresponding to each leaf node; and the device includes: a determining unit, configured to determine a target location identifier based on the parameter information of the decision tree in a decision forest, where a leaf node corresponding to the target location identifier matches service data; and a transfer unit, configured to perform oblivious transfer with a first device by using the target location identifier as an input; and selecting a target leaf value ciphertext from leaf value ciphertexts that correspond to leaf nodes in the decision tree in the decision forest and that are input by the first device, where the leaf value ciphertexts corresponding to the leaf nodes are obtained by encrypting the leaf values corresponding to the leaf nodes with a random number.

According to a ninth aspect of one or more implementations of the present specification, an electronic device is provided, including: a memory, configured to store computer instructions; and a processor, configured to execute the computer instructions to implement method steps according to the seventh aspect.

According to the technical solutions in the implementations of the present specification, in the implementations of the present specification, the first device and/or the second device can obtain a predication result of the decision forest or obtain a comparison result while the first device does not disclose the decision forest and the second device does not disclose service data. The comparison result is used to indicate a comparison in values between the predication result and the preset threshold.

### BRIEF DESCRIPTION OF DRAWINGS

To describe the technical solutions in the implementations of the present specification or in the existing technology more clearly, the following briefly introduces the accompanying drawings for illustrating such technical solutions. Clearly, the accompanying drawings outlined below are some implementations of the present specification, and a person skilled in the art can derive other drawings from such accompanying drawings without creative efforts.

FIG. 1 is a schematic structural diagram illustrating a decision tree, according to an implementation of the present specification;

FIG. 2 is a flowchart illustrating a data processing method, according to an implementation of the present specification;

FIG. 3 is a schematic structural diagram illustrating a full binary tree, according to an implementation of the present specification;

FIG. 4 is a flowchart illustrating a data processing method, according to an implementation of the present specification;

FIG. 5 is a flowchart illustrating oblivious transfer, according to an implementation of the present specification;

FIG. 6 is a schematic diagram illustrating a data processing method, according to an implementation of the present specification;

FIG. 7 is a flowchart illustrating a data processing method, according to an implementation of the present specification;

FIG. 8 is a functional schematic structural diagram illustrating a data processing device, according to an implementation of the present specification;

FIG. 9 is a functional schematic structural diagram illustrating a data processing device, according to an implementation of the present specification;

FIG. 10 is a functional schematic structural diagram illustrating a data processing device, according to an implementation of the present specification; and

FIG. 11 is a functional schematic structural diagram illustrating an electronic device, according to an implementation of the present specification.

### DESCRIPTION OF IMPLEMENTATIONS

The technical solutions in the implementations of the present specification are described below clearly and comprehensively with reference to the accompanying drawings in the implementations of the present specification. Clearly, the described implementations are merely some of the implementations of the present specification, rather than all of the implementations. Based on the implementations of the present specification, a person skilled in the art can obtain other implementations without making creative efforts, which all fall within the scope of the present specification. In addition, it should be understood that although terms “first”, “second”, “third”, etc. can be used in the present specification to describe various types of information, the information is not limited to these terms. These terms are only used to differentiate information of a same type. For example, without departing from the scope of the present specification, first information can also be referred to as second information, and similarly, the second information can also be referred to as the first information.

To enable a person skilled in the art to have a better understanding of the technical solutions in the implementations of the present specification, the following first describes technical terms used in the implementations of the present specification.

Decision tree: a supervised machine learning model. The decision tree can be a binary tree, etc. The decision tree includes a plurality of nodes. Each node can have a corresponding location identifier. The location identifier can be used to identify a location of the node in the decision tree. For example, the location identifier can be a number of the node. The plurality of nodes can form a plurality of prediction paths. A start node of a prediction path is a root node of the decision tree, and an end node of the prediction path is a leaf node of the decision tree.

The decision tree can include a regression decision tree and a classification decision tree. A prediction result of the regression decision tree can be a specific numerical value. A prediction result of the classification decision tree can be a specific category. It is worthwhile to note that, for ease of computation, a category is usually indicated by a vector. For example, vector [1 0 0] can indicate category A, vector [0 1 0] can indicate category B, and vector [0 0 1] can indicate category C. Certainly, the vectors are only examples. In actual applications, a category can be indicated by using another mathematical method.

Burst node: When a node in a decision tree can be downstream split, the node can be referred to as a burst node. The burst node can include a root node or a common node (that is, a node other than a leaf node and a root node). The burst node has a corresponding splitting criterion, and the splitting criterion can be used to select a prediction path.

Leaf node: When a node in a decision tree cannot be downstream split, the node can be referred to as a leaf node. Each leaf node corresponds to a leaf value. Different leaf nodes in a decision tree can have a same or different corresponding leaf values. Each leaf node can indicate a precision result. The leaf node can be a numerical value, a vector, etc. For example, a leaf value corresponding to a leaf node of the regression decision tree can be a numerical value, and a leaf value corresponding to a leaf node of the classification decision tree can be a vector.

Full binary tree: When each node on each layer other than the last layer can be split into two nodes, the binary tree is referred to as a full binary tree.

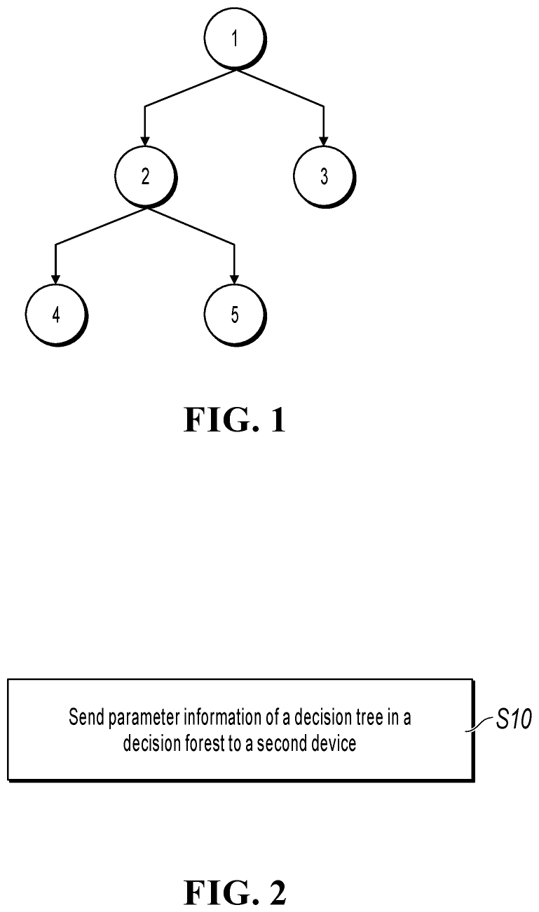

To facilitate understanding of the previous terms, the following describes an example scenario. Refer to FIG. 1. In the example scenario, decision tree Tree1 can include five nodes: nodes 1, 2, 3, 4, and 5. Location identifiers of nodes 1, 2, 3, 4, and 5 can be 1, 2, 3, 4, and 5, respectively. Node 1 is a root node; nodes 1 and 2 are common nodes; and nodes 3, 4, and 5 are leaf nodes. Nodes 1, 2, and 4 can form a prediction path; nodes 1, 2, and 5 can form another prediction path; and nodes 1 and 3 can form still another prediction path.

Splitting criteria corresponding to nodes 1, 2, and 3 are shown in Table 1.

TABLE 1

| Node | Splitting criterion |
|---|---|
| Node 1 | The age is over 20 years. |
| Node 2 | The annual income is over 50,000 yuan. |

Leaf values corresponding to nodes 3, 4, and 5 are shown in Table 2.

TABLE 2

| Node | Leaf value |
|---|---|
| Node 3 | 200 |
| Node 4 | 700 |
| Node 5 | 500 |

The splitting criteria “the age is over 20 years” and “the annual income is over 50,000 yuan” can be used to select a prediction path. When the splitting criterion is met, the prediction path on the left can be selected; when the splitting criterion is not met, the prediction path on the right can be selected. Specifically, for node 1, when the splitting criterion “the age is over 20 years” is met, the prediction path on the left can be selected, and then node 2 is jumped to; or when the splitting criterion “the age is over 20 years” is not met, the prediction path on the right can be selected, and then node 3 is jumped to. For node 2, when the splitting criterion “the annual income is over 50,000 yuan” is met, the prediction path on the left can be selected, and then node 4 is jumped to; or when the splitting criterion “the annual income is over 50,000 yuan” is not met, the prediction path on the right can be selected, and then node 5 is jumped to.

One or more decision trees can form a decision forest. A plurality of decision trees can be integrated into a decision forest by using algorithms such as Random Forest, Extreme Gradient Boosting (XGBoost), and Gradient Boosting Decision Tree (GBDT). The decision forest is a supervised machine learning model, and can include a regression decision forest and a classification decision forest. The regression decision forest can include one or more regression decision trees. When the regression decision forest includes one regression decision tree, the prediction result of the regression decision tree can be used as the prediction result of the regression decision forest. When the regression decision forest includes a plurality of regression decision trees, summation can be performed on the prediction results of the plurality of regression decision trees, and the summation result can be used as the prediction result of the regression decision forest. The classification decision forest can include one or more classification decision trees. When the classification decision forest includes one classification decision tree, the prediction result of the classification decision tree can be used as the prediction result of the classification decision forest. When the classification decision forest includes a plurality of classification decision trees, statistical collection can be performed on the prediction results of the plurality of classification decision trees, and the result of the statistical collection can be used as the prediction result of the classification decision forest. It is worthwhile to note that, in some scenarios, the prediction result of the classification decision tree can be a vector, and the vector can be used to indicate a category. As such, summation can be performed on the prediction results of the plurality of classification decision trees, and the summation result can be used as the prediction result of the classification decision forest. For example, a classification decision tree can include the following decision trees: Tree2, Tree3, and Tree4. The prediction result of Tree2 can be vector [1 0 0], and [1 0 0] indicates category A. The prediction result of Tree3 can be vector [0 1 0], and [0 1 0] indicates category B. The prediction result of Tree4 can be vector [1 0 0], and [0 0 1] indicates category C. Then, summation can be performed on [1 0 0], [0 1 0], and [1 0 0], and the obtained vector [2 1 0] can be used as the prediction result of the classification decision forest. Vector [2 1 0] indicates that the quantity of times that the prediction result of the classification decision forest is category A is 2, the quantity of times that the prediction result of the classification decision forest is category B is 1, and the quantity of times that the prediction result of the classification decision forest is category C is 0.

The present specification provides a data processing system. The data processing system can include a first device and a second device. The first device can be a server, a mobile phone, a tablet computer, a personal computer, etc. Alternatively, the first device can be a system including a plurality of devices, for example, a server cluster including a plurality of servers. The first device has a decision forest that needs to be kept secret. The second device can be a server, a mobile phone, a tablet computer, a personal computer, etc. Alternatively, the second device can be a system including a plurality of devices, for example, a server cluster including a plurality of servers. The second device has service data that needs to be kept secret. For example, the service data can be transaction data or loan data.

The first device and the second device can perform collaborative computation, so that the first device and/or the second device can obtain a prediction result based on a prediction using the decision forest. In this process, the first device cannot disclose its decision forest, and the second device cannot disclose its service data. In an example scenario, the first device belongs to a financial institution. The second device belongs to a data institution, for example, a big data company or a government entity.

Based on the data processing system, the present specification provides an implementation of a data processing method. In actual applications, the implementation can be applied to a pre-processing phase. Refer to FIG. 2. The execution entity of the implementation is a first device. The implementation can include the following steps.

Step S10: Send parameter information of a decision tree in a decision forest to a second device.

In some implementations, the decision forest can include at least one decision tree. The first device can send the parameter information of each decision tree in the decision forest to the second device. The second device can receive the parameter information of each decision tree in the decision forest. The parameter information can include a location identifier corresponding to a burst node, a splitting criterion corresponding to the burst node, and a location identifier corresponding to each leaf node, but does not include a leaf value corresponding to each leaf node. As such, the second device can obtain a splitting criterion corresponding to a burst node in a decision tree in the decision forest, but cannot obtain a leaf value corresponding to a leaf node of the decision tree in the decision forest, thereby protecting privacy of the decision forest.

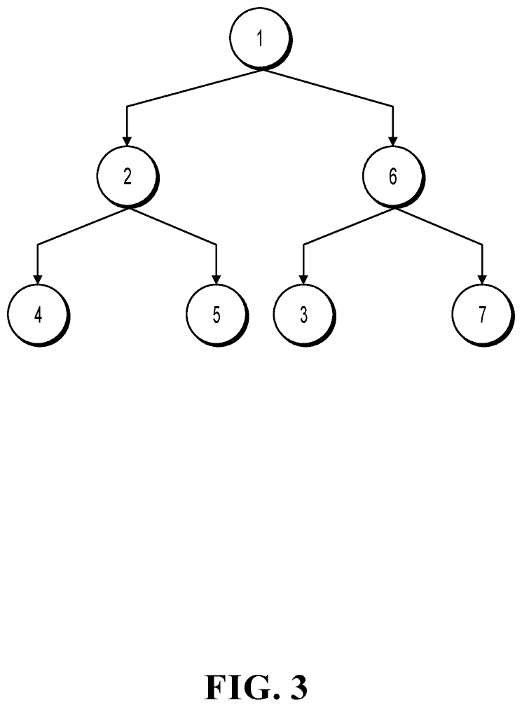

In some implementations, one or more decision trees in the decision forest are non-full binary trees. As such, before step S10, the first device can one or more fake trees to the decision forest. As such, the privacy of the decision forest is better protected. For example, refer to FIG. 3. Tree1 shown in FIG. 1 is a non-full binary tree. The first device can add fake nodes 6 and 7 to Tree1 shown in FIG. 1. The splitting criterion corresponding to node 6 can be generated randomly or based on a specific policy. The leaf value corresponding to node 7 is the same as the leaf value corresponding to node 3.

In some implementations, before step S10, the first device can add one or more fake trees to the decision forest. As such, the privacy of the decision forest is better protected. The quantity of layers of a fake decision tree can be the same as or different from the quantity of layers of a real decision tree in the decision forest. The splitting criterion corresponding to a burst node in the fake decision tree can be generated randomly or based on a specific policy. A leaf value corresponding to a leaf node of the fake decision tree can be a specific value, for example, 0.

Further, after adding a fake decision tree, the first device can perform out-of-order processing of the decision trees in the decision forest. As such, a real decision tree and a fake decision tree cannot be guessed out by the second device in a subsequent process.

According to the data processing method provided in this implementation of the present specification, the first device can send parameter information of a decision tree in a decision forest to the second device. The parameter information can include a location identifier corresponding to a burst node, a splitting criterion corresponding to the burst node, and a location identifier corresponding to each leaf node, but does not include a leaf value corresponding to each leaf node. As such, the privacy of the decision forest is protected. In addition, the second device can easily predict service data based on the decision forest.

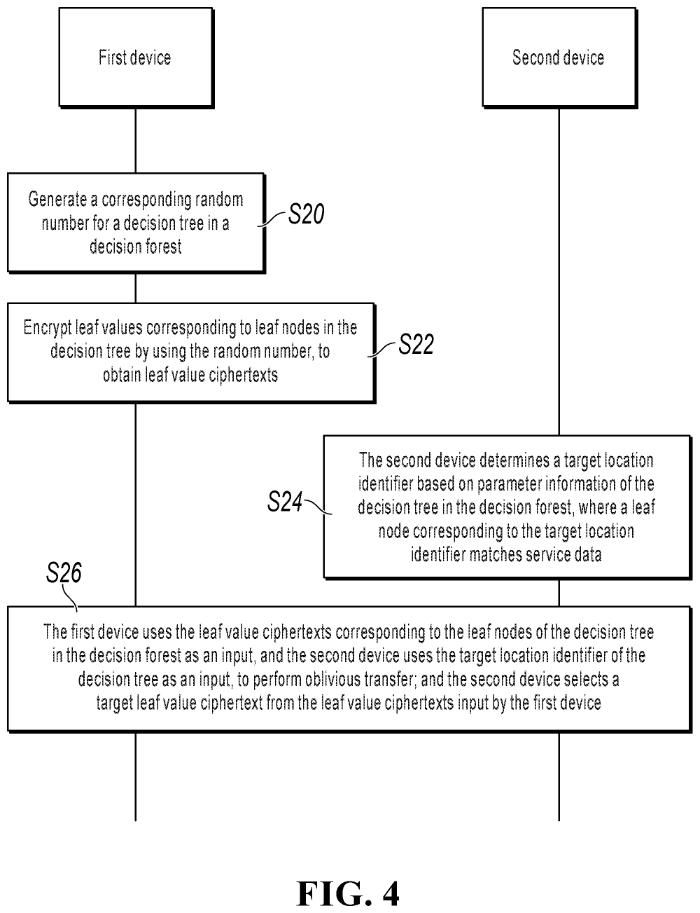

Based on the data processing system, the present specification provides another implementation of a data processing method. In actual applications, the implementation can be applied to a prediction phase. Refer to FIG. 4. This implementation can include the following steps.

Step S20: A first device generates a corresponding random number for a decision tree in a decision forest.

In some implementations, the decision forest can include one decision tree. As such, the first device can generate one corresponding random number for the decision tree.

In some other implementations, the decision forest can include a plurality of decision trees. As such, the first device can generate a plurality of random numbers for the plurality of decision trees. The sum of the plurality of random numbers can be a specific value. The specific value can be a completely random number. Specifically, the first device can generate one corresponding random number for each of the decision trees, so that the specific value is a completely random number. Alternatively, the specific value can be a fixed value 0. For example, the decision forest includes k decision trees. The first device can generate k−1 random numbers r₁, r₂, . . . , r₁, . . . , rₖ₋₁ for the k−1 decision trees, and can compute rₖ=0−(r₁+r₂+ . . . +rᵢ+ . . . +rₖ₋₁) for use as a random number corresponding to the k^{th} decision tree. Alternatively, the specific value can be pre-generated noise data (hereafter referred to as first noise data for ease of description). For example, the decision forest includes k decision trees. The first device can generate k−1 random numbers r₁, r₂, . . . , r₁, . . . , rₖ₋₁ for the k−1 decision trees, and can compute rₖ=s−(r₁+r₂+ . . . +rᵢ+ . . . +rₖ₋₁) for use as a random number corresponding to the kt^{h} decision tree. Here s indicates the first noise data.

Step S22: The first device encrypts leaf values corresponding to leaf nodes in the decision tree of the decision tree forest by using the random number, to obtain leaf value ciphertexts.

In some implementations, for each decision tree in the decision forest, the first device can encrypt a leaf value corresponding to each leaf node of the decision tree by using the random number corresponding to the decision tree, to obtain a leaf value ciphertext. In actual applications, the first device can add up the random number corresponding to the decision tree and the leaf value corresponding to each leaf node of the decision tree. For example, the decision forest includes k decision trees, and random numbers corresponding to the k decision trees are r₁, r₂, . . . , rᵢ. . . , rₖ, where rᵢ indicates the random number corresponding to the i^{th} decision tree. The i^{th} decision tree can include N leaf nodes, and leaf values corresponding to the N leaf nodes are v_i₁, v_i₂, . . . , v_iⱼ, . . . , v_i_{N}, where v_iⱼ indicates the leaf value corresponding to the j^{th} leaf node of the i^{th} decision tree. Then, the first device can add up the random number rᵢ and each of the leaf nodes v_i₁, v_i₂, . . . , v_iⱼ, . . . , v_i_{N} corresponding to the N leaf nodes, to obtain leaf value ciphertexts v_i₁+rᵢ, v_i₂+rᵢ, . . . , v_iⱼ+rᵢ, . . . , v_i_{N}+rᵢ.

Step S24: A second device determines a target location identifier based on parameter information of the decision tree, where a leaf node corresponding to the target location identifier matches service data.

In some implementations, after the pre-processing phase ends (for a specific process, references can be made to the implementation corresponding to FIG. 2), the second device can obtain the parameter information of each decision tree in the decision forest. The second device can reconstruct a framework of a decision tree based on the parameter information. Because the parameter information includes a splitting criterion corresponding to a burst node, but does not include a leaf value corresponding to a leaf node, the reconstructed decision tree framework includes the splitting criterion corresponding to the burst node, but does not include the leaf value corresponding to the leaf node. As such, the second device can obtain a prediction path matching service data based on the framework of each decision tree of the decision forest; use a leaf node in the prediction path as a target leaf node matching the service data in the decision tree; and use a location identifier corresponding to the target leaf node as a target location identifier.

Step S26: The first device uses the leaf value ciphertexts corresponding to the leaf nodes of the decision tree in the decision forest as an input, and the second device uses the target location identifier of the decision tree as an input, to perform oblivious transfer; and the second device selects a target leaf value ciphertext from the leaf value ciphertexts input by the first device.

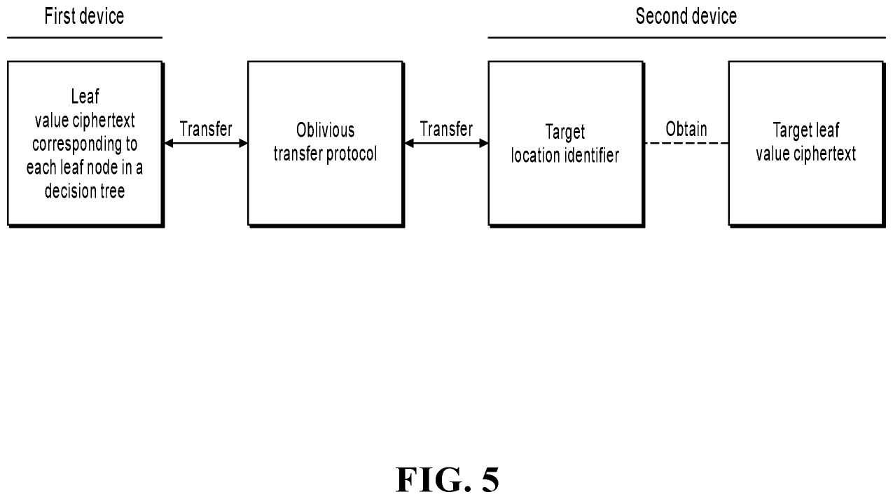

Refer to FIG. 5. In some implementations, oblivious transfer (OT) is a duplex protocol for protecting privacy. It allows communication parties to transfer data in a fuzzy selection manner. The sender can have a plurality of pieces of data. The receiver can receive one or more of the plurality of pieces of data through oblivious transfer. In this process, the sender does not know the data received by the receiver; and the receiver cannot obtain any data other than the received data. In this implementation, the first device can use the leaf value ciphertexts corresponding to the leaf nodes of the decision tree in the decision forest as an input, and the second device can use the target location identifier of the decision tree as an input, to perform oblivious transfer. Based on oblivious transfer, the second device can obtain the target leaf value ciphertext from the leaf value ciphertexts input by the first device, and the target leaf value ciphertext is the leaf value ciphertext corresponding to the target leaf node. The leaf value ciphertext corresponding to each leaf node in the decision tree can be considered as secret information that is input by the first device during oblivious transfer, and the target location identifier of the decision tree can be determined as selection information that is input by the second device during oblivious transfer. As such, the second device can select the target leaf value ciphertext. Based on features of oblivious transfer, the first device does not know which leaf value ciphertext is selected by the second device as the target leaf value ciphertext, and the second device does not know any leaf value ciphertext other than the selected target leaf value ciphertext. It is worthwhile to note that any existing oblivious transfer protocol can be used here. A specific transfer protocol is not described here.

In some implementations, the second device obtains a prediction result of a decision forest.

In an implementation, the decision forest can include one decision tree, and in this case, the second device can obtain one target leaf value ciphertext. As such, the second device can use the target leaf value ciphertext as the prediction result of the decision forest.

In another implementation, the decision forest can include a plurality of decision trees, and in this case, the second device can obtain a plurality of target leaf value ciphertexts. As such, the second device can perform summation on the plurality of target leaf value ciphertexts, to obtain a first summation result; and use the first summation result as the prediction result of the decision forest. For example, the decision forest includes k decision trees, and random numbers corresponding to the k decision trees are r₁ r₂, . . . , rᵢ, . . . , rₖ, where rᵢ indicates the random number corresponding to the i^{th} decision tree. The sum of the random numbers corresponding to the k decision trees is r₁+r₂+ . . . +rᵢ+ . . . +rₖ=0 . The k target leaf value ciphertexts selected by the second device are v_1ₚ_{₁}+r₁, v_2ₚ_{₂}+r₂, . . . , v_iₚ_{ᵢ}+rᵢ, . . . , v_kₚ_{ₖ}+rₖ, where v_iₚ_{ᵢ}+rᵢ indicates the target leaf value ciphertext selected by the second device from the i^{th} decision tree, and the target leaf value ciphertext v_iₚ_{ᵢ}+rᵢ is the leaf value cipher corresponding to the leaf node with a location identifier of pᵢ in the i^{th} decision tree. As such, the second device can compute (v_1ₚ_{₁}+r₁)+(v_2ₚ_{₂}+r₂)+ . . . +(v_iₚ_{ᵢ}+rᵢ)+ . . . +(v_kₚ_{ₖ}+rₖ) =v_1ₚ_{₁}+v_2ₚ_{₂}+ . . . +v_iₚ_{ᵢ}+ . . . , +v_kₚ_{ₖ}=u, to obtain the prediction result u of the decision forest. For another example, the decision forest includes k decision trees, and random numbers corresponding to the k decision trees are r₁r₂, . . . , rᵢ, . . . , rₖ, where rᵢ indicates the random number corresponding to the i^{th} decision tree. The sum of the random numbers corresponding to the k decision trees is r₁+r₂+ . . . +r₁+ . . . +rₖ=s, where s indicates the first noise data. The k target leaf value ciphertexts selected by the second device are v_1ₚ_{₁}+r₁, v_2ₚ_{₂}+r₂, . . . , v_iₚ_{ᵢ}+rᵢ, . . . , v_kₚ_{ₖ}+rₖ, where v_iₚ_{ᵢ}+rᵢ indicates the target leaf value ciphertext selected by the second device from the i^{th} decision tree, and the target leaf value ciphertext v_iₚ_{ᵢ}+rᵢ is the leaf value cipher corresponding to the leaf node with a location identifier of pᵢ in the i^{th} decision tree. As such, the second device can compute (v_1ₚ_{₁}+r₁)+(v_2ₚ_{₂}+r₂)+ . . . +(v_iₚ_{ᵢ}+rᵢ)+ . . . +(v_kₚ_{ₖ}+rₖ) =v_1ₚ_{₁}+v_2ₚ_{₂}+ . . . +v_iₚ_{ᵢ}+v_kₚ_{ₖ}+s=u+s, to obtain the prediction result with the first noise data, namely, u+s.

In some other implementations, the first device obtains a prediction result of a decision forest.

In an implementation, the decision forest can include one decision tree, and in this case, the second device can obtain one target leaf value ciphertext. As such, the second device can send the target leaf value ciphertext to the first device. The first device can receive the target leaf value ciphertext; and decrypt the target leaf value ciphertext by using a random number corresponding to the decision tree, to obtain a leaf value as the prediction result of the decision forest. The first device can compute a difference between the target leaf value ciphertext and the random number, to obtain the leaf value. Alternatively, the second device can perform summation on the target leaf value ciphertext and noise data (hereafter referred to as second noise data for ease of description), to obtain a first summation result; and send the first summation result to the first device. The first device can receive the first summation result; and decrypt the first summation result by using the random number corresponding to the decision tree, to obtain a leaf value after mixing with the second noise data, namely, the prediction result with the second noise data. The size of the second noise data can be flexibly set as required, which is usually less than the size of the service data. The first device can compute a difference between the first summation result and the random number, to obtain the leaf value with the second noise data.

In another implementation, the decision forest can include a plurality of decision trees, and in this case, the second device can obtain a plurality of target leaf value ciphertexts. As such, the second device can perform summation on the plurality of target leaf value ciphertexts, to obtain a second summation result; and send the second summation result to the first device. The first device can receive the second summation result; and decrypt the second summation result by using the sum of the random numbers corresponding to the decision trees in the decision forest, to obtain the prediction result of the decision forest. The first device can compute a difference between the second summation result and the sum of the random numbers, to obtain the prediction result of the decision forest. For example, the decision forest includes k decision trees, and random numbers corresponding to the k decision trees are r₁, r₂, . . . , rᵢ, . . . , rₖ, where rᵢ indicates the random number corresponding to the i^{th} decision tree. The sum of the random numbers corresponding to the k decision trees is r₁+r₂+ . . . +rᵢ+ . . . +rₖ=r, where r is a completely random number. The k target leaf value ciphertexts selected by the second device are v_1ₚ_{₁}+r₁, v_2ₚ_{₂}+r₂, . . . , v_iₚ_{ᵢ}+rᵢ, . . . , v_kₚ_{ₖ}+rₖ, where v_iₚ_{ᵢ}+rᵢ indicates the target leaf value ciphertext selected by the second device from the i^{th} decision tree, and the target leaf value ciphertext v_iₚ_{ᵢ}+rᵢ is the leaf value cipher corresponding to the leaf node with a location identifier of pᵢ in the i^{th} decision tree. Then, the second device can compute the second summation result; (v_1ₚ_{₁}+r₁)+(v_2ₚ_{₂}+r₂)+ . . . +(v_iₚ_{ᵢ}rᵢ)+ . . . +(v_kₚ_{ₖ}+rₖ) =v_1ₚ_{₁}+v_2ₚ_{₂}+ . . . +v_iₚ_{ᵢ}+ . . . kₚ_{ₖ}+r=u+r; and send the second summation result u+r to the first device. The first device can receive the second summation result u+r; and compute a difference between the second summation result u+r and the sum r of the random numbers corresponding to the decision trees in the decision forest, to obtain the prediction result u of the decision forest. Alternatively, the second device can perform summation on the second summation result and the second noise data, to obtain a third summation result; and send the third summation result to the first device. The first device can receive the third summation result; and decrypt the third summation result by using the sum of the random numbers corresponding to the decision trees in the decision forest, to obtain the prediction result with the second noise data. The first device can compute a difference between the third summation result and the sum of the random numbers, to obtain the prediction result with the second noise data.

In other implementations, the first device and/or the second device obtain/obtains a comparison result. The comparison result is used to indicate a comparison in values between the predication result of the decision forest and a preset threshold. The preset threshold can be flexibly set as required. In actual applications, the preset threshold can be a threshold value. When the prediction value is greater than the preset threshold, a preset operation can be performed; or when the preset value is less than the preset threshold, another preset operation can be performed. For example, the preset value can be a threshold value used in the risk evaluation business. The predication result of the decision forest can be a credit score of a user. When the credit score of a user is greater than the preset threshold, it indicates that the risk level of the user is high, and the loan request of the user can be rejected; or when the credit score of the user is less than the preset threshold, it indicates that the risk level of the user is low, and the loan request of the user can be approved.

In an implementation, the decision forest can include one decision tree, and in this case, the second device can obtain one target leaf value ciphertext. As such, the first device can perform summation on the random number corresponding to the decision tree and the preset threshold, to obtain a fourth summation result. The first device can use the fourth summation result as an input, and the second device can use the target leaf value cipher as an input, to jointly execute a secure multi-party comparison algorithm. Based on execution of the secure multi-party comparison algorithm, the first device and/or the second device can obtain the first comparison result while the first device does not disclose the fourth summation result and the second device does not disclose the target leaf value ciphertext. The first comparison result indicates a comparison in values between the fourth summation result and the target leaf value ciphertext. Because the target leaf value ciphertext is obtained by adding up the random number corresponding to the decision tree and the leaf value corresponding to the leaf node, the first comparison result can also indicate a comparison in values between plaintext data (namely, leaf value) corresponding to the target leaf node and the preset threshold, where the plaintext data corresponding to the target leaf node is the prediction result of the decision forest. It is worthwhile to note that any existing secure multi-party comparison algorithm can be used here. A specific comparison process is not described here.

In another implementation, the decision forest can include a plurality of decision trees, and in this case, the second device can obtain a plurality of target leaf value ciphertexts. As such, the second device can perform summation on the plurality of target leaf value ciphertexts, to obtain a second summation result. The first device performs summation on the random numbers corresponding to the decision trees in the decision forest; and can perform summation on the sum of the random numbers and the preset threshold, to obtain a fourth summation result. The first device can use the fourth summation result as an input, and the second device can use the second summation result as an input, to jointly execute a secure multi-party comparison algorithm. Based on execution of the secure multi-party comparison algorithm, the first device and/or the second device can obtain the second comparison result while the first device does not disclose the fourth summation result and the second device does not disclose the second summation result. The second comparison result indicates a comparison in values between the fourth summation result and the second summation result. Because the target leaf value ciphertext is obtained by adding up the random number corresponding to the decision tree and the leaf value corresponding to the leaf node, and the second summation result is obtained by adding up the plurality of target leaf value ciphertexts, the second comparison result can also indicate a comparison in values between the sum of leaf values corresponding to the plurality of target leaf nodes and the preset threshold, where the sum of leaf values corresponding to the plurality of target leaf nodes is the prediction result of the decision forest.

According to the data processing method provided in this implementation of the present specification, the first device can generate the random number corresponding to the decision tree in the decision forest; and encrypt leaf values corresponding to leaf nodes in the decision tree in the decision forest by using the random number, to obtain leaf value ciphertexts. The second device can determine the target location identifier based on the parameter information of the decision tree. The first device can use the leaf value ciphertexts corresponding to the leaf nodes of the decision tree in the decision forest as an input, and the second device can use the target location identifier of the decision tree as an input, to perform oblivious transfer; and the second device can select a target leaf value ciphertext from the leaf value ciphertexts input by the first device. As such, based on oblivious transfer, the first device and/or the second device can obtain a predication result of the decision forest or obtain a comparison result while the first device does not disclose the decision forest and the second device does not disclose service data. The comparison result is used to indicate a comparison in values between the predication result and the preset threshold.

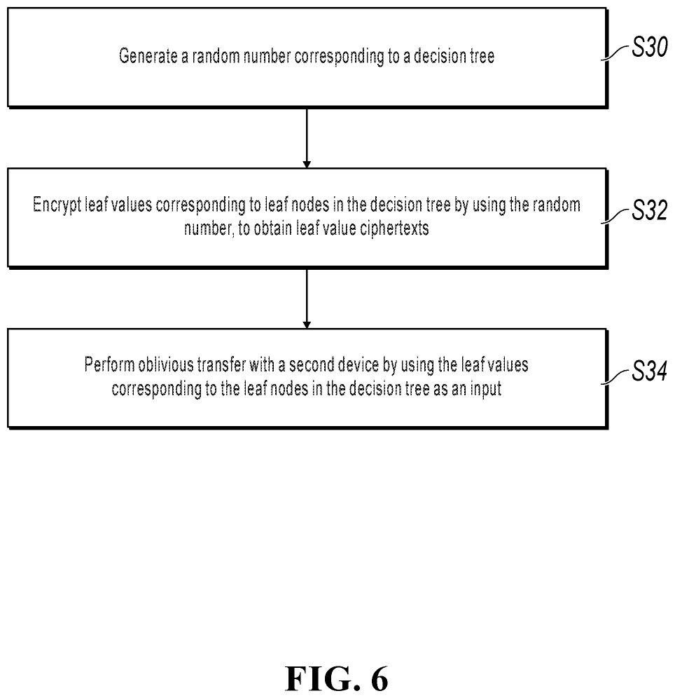

The present specification further provides another implementation of a data processing method. In actual applications, the implementation can be applied to a prediction phase. Refer to FIG. 6. The execution entity of the implementation is a first device. The first device can provide a decision forest, and the decision forest includes at least one decision tree. This implementation can include the following steps.

Step S30: Generate a random number corresponding to a decision tree.

In some implementations, the decision forest can include one decision tree. As such, the first device can generate one corresponding random number for the decision tree.

In some other implementations, the decision forest can include a plurality of decision trees. As such, the first device can generate a plurality of random numbers for the plurality of decision trees. The sum of the plurality of random numbers can be a specific value. The specific value can be a completely random number, a fixed value 0, or pre-generated noise data.

Step S32: Encrypt leaf values corresponding to leaf nodes in the decision tree by using the random number, to obtain leaf value ciphertexts.

In some implementations, for each decision tree in the decision forest, the first device can encrypt a leaf value corresponding to each leaf node of the decision tree by using the random number corresponding to the decision tree, to obtain a leaf value ciphertext. In actual applications, the first device can add up the random number corresponding to the decision tree and the leaf value corresponding to each leaf node of the decision tree.

Step S34: Perform oblivious transfer with a second device by using the leaf values corresponding to the leaf nodes in the decision tree as an input.

In some implementations, the second device can obtain a target location identifier. For a process in which the second device obtains the target location identifier, references can be made to the previous implementations. As such, the first device can use the leaf value ciphertexts corresponding to the leaf nodes of the decision tree in the decision forest as an input, and the second device can use the target location identifier of the decision tree as an input, to perform oblivious transfer. Based on oblivious transfer, the second device can obtain the target leaf value ciphertext from the leaf value ciphertexts input by the first device, and the target leaf value ciphertext is the leaf value ciphertext corresponding to the target leaf node. The leaf value ciphertext corresponding to each leaf node in the decision tree can be considered as secret information that is input by the first device during oblivious transfer, and the target location identifier of the decision tree can be determined as selection information that is input by the second device during oblivious transfer. As such, the second device can select the target leaf value ciphertext. Based on features of oblivious transfer, the first device does not know which leaf value ciphertext is selected by the second device as the target leaf value ciphertext, and the second device does not know any leaf value ciphertext other than the selected target leaf value ciphertext.

According to the data processing method provided in this implementation of the present specification, the first device can generate a random number corresponding to the decision tree; encrypt leaf values corresponding to leaf nodes in the decision tree by using the random number, to obtain leaf value ciphertexts; and perform oblivious transfer with the second device by using the leaf values corresponding to the leaf nodes in the decision tree as an input. Based on oblivious transfer, the first device can send the target leaf value ciphertext without disclosing its decision forest, to predict the service data based on the decision forest.

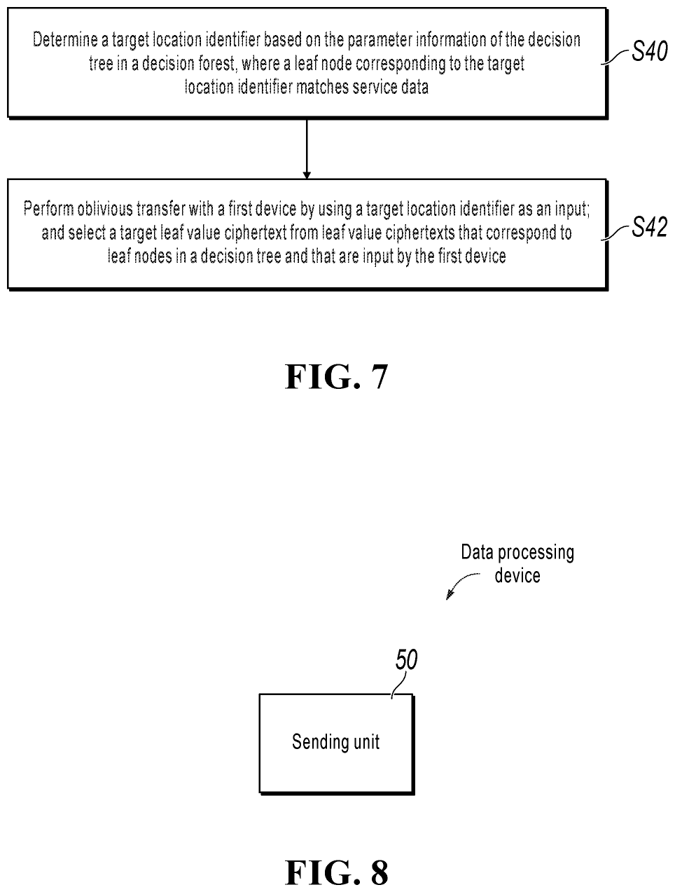

The present specification further provides another implementation of a data processing method. In actual applications, the implementation can be applied to a prediction phase. Refer to FIG. 7. The execution entity of the implementation is a second device. The second device can provide parameter information of each decision tree in the decision forest. The parameter information can include a location identifier corresponding to a burst node, a splitting criterion corresponding to the burst node, and a location identifier corresponding to each leaf node, but does not include a leaf value corresponding to each leaf node. This implementation can include the following steps.

Step S40: Determine a target location identifier based on the parameter information of the decision tree in a decision forest, where a leaf node corresponding to the target location identifier matches service data;

In some implementations, after the pre-processing phase ends (for a specific process, references can be made to the implementation corresponding to FIG. 2), the second device can obtain the parameter information of each decision tree in the decision forest. The second device can reconstruct a framework of a decision tree based on the parameter information. Because the parameter information includes a splitting criterion corresponding to a burst node, but does not include a leaf value corresponding to a leaf node, the reconstructed decision free framework includes the splitting criterion corresponding to the burst node, but does not include the leaf value corresponding to the leaf node. As such, the second device can obtain a prediction path matching service data based on the framework of each decision tree of the decision forest; use a leaf node in the prediction path as a target leaf node matching the service data in the decision tree; and use a location identifier corresponding to the target leaf node as a target location identifier.

Step S42: Perform oblivious transfer with the first device by using the target location identifier as an input; and select a target leaf value ciphertext from leaf value ciphertexts that correspond to leaf nodes in the decision tree and that are input by the first device.

In some implementations, the first device can use the leaf value ciphertexts corresponding to the leaf nodes of the decision tree in the decision forest as an input, and the second device can use the target location identifier of the decision tree as an input, to perform oblivious transfer. Based on oblivious transfer, the second device can obtain the target leaf value ciphertext from the leaf value ciphertexts input by the first device, and the target leaf value ciphertext is the leaf value ciphertext corresponding to the target leaf node. The leaf value ciphertext corresponding to each leaf node in the decision tree can be considered as secret information that is input by the first device during oblivious transfer, and the target location identifier of the decision tree can be determined as selection information that is input by the second device during oblivious transfer. As such, the second device can select the target leaf value ciphertext. Based on features of oblivious transfer, the first device does not know which leaf value ciphertext is selected by the second device as the target leaf value ciphertext, and the second device does not know any leaf value ciphertext other than the selected target leaf value ciphertext.

In some implementations, the second device obtains a prediction result of a decision forest.

In an implementation, the decision forest can include one decision tree, and in this case, the second device can obtain one target leaf value ciphertext. As such, the second device can directly use the target leaf value ciphertext as the prediction result of the decision forest.

In another implementation, the decision forest can include a plurality of decision trees, and in this case, the second device can obtain a plurality of target leaf value ciphertexts. As such, the second device can perform summation on the plurality of target leaf value ciphertexts, to obtain a first summation result; and use the first summation result as the prediction result of the decision forest.

In some other implementations, the first device obtains a prediction result of a decision forest.

In an implementation, the decision forest can include one decision tree, and in this case, the second device can obtain one target leaf value ciphertext. As such, the second device can send the target leaf value ciphertext to the first device. The first device can receive the target leaf value ciphertext; and decrypt the target leaf value ciphertext by using a random number corresponding to the decision tree, to obtain the prediction result of the decision forest, namely, a leaf value. Alternatively, the second device can perform summation on the target leaf value ciphertext and noise data, to obtain a first summation result; and send the first summation result to the first device. The first device can receive the first summation result; and decrypt the first summation result by using the random number corresponding to the decision tree, to obtain a leaf value after mixing with the noise data, namely, the prediction result with the noise data.

In another implementation, the decision forest can include a plurality of decision trees, and in this case, the second device can obtain a plurality of target leaf value ciphertexts. As such, the second device can perform summation on the plurality of target leaf value ciphertexts, to obtain a second summation result; and send the second summation result to the first device. The first device can receive the second summation result; and decrypt the second summation result by using the sum of the random numbers corresponding to the decision trees in the decision forest, to obtain the prediction result of the decision forest. Alternatively, the second device can perform summation on the second summation result and the noise data, to obtain a third summation result; and send the third summation result to the first device. The first device can receive the third summation result; and decrypt the third summation result by using the sum of the random numbers corresponding to the decision trees in the decision forest, to obtain the prediction result with the noise data.

In some other implementations, the first device and/or the second device can obtain a comparison result. The comparison result is used to indicate a comparison in values between the predication result of the decision forest and a preset threshold. The preset threshold can be flexibly set as required. In actual applications, the preset threshold can be a threshold value.

In an implementation, the decision forest can include one decision tree, and in this case, the second device can obtain one target leaf value ciphertext. As such, the first device can perform summation on the random number corresponding to the decision tree and the preset threshold, to obtain a fourth summation result. The first device can use the fourth summation result as an input, and the second device can use the target leaf value cipher as an input, to jointly execute a secure multi-party comparison algorithm. Based on execution of the secure multi-party comparison algorithm, the first device and/or the second device can obtain the first comparison result while the first device does not disclose the fourth summation result and the second device does not disclose the target leaf value ciphertext. The first comparison result is used to indicate a comparison in values between the fourth summation result and the target leaf value ciphertext; and can further indicate a comparison in values between plaintext data (namely, leaf value) corresponding to the target leaf node and the preset threshold, where the plaintext data corresponding to the target leaf node is the prediction result of the decision forest.

In another implementation, the decision forest can include a plurality of decision trees, and in this case, the second device can obtain a plurality of target leaf value ciphertexts. As such, the second device can perform summation on the plurality of target leaf value ciphertexts, to obtain a second summation result. The first device performs summation on the random numbers corresponding to the decision trees in the decision forest; and can perform summation on the sum of the random numbers and the preset threshold, to obtain a fourth summation result. The first device can use the fourth summation result as an input, and the second device can use the second summation result as an input, to jointly execute a secure multi-party comparison algorithm. Based on execution of the secure multi-party comparison algorithm, the first device and/or the second device can obtain the second comparison result while the first device does not disclose the fourth summation result and the second device does not disclose the second summation result. The second comparison result is used to indicate a comparison in values between the fourth summation result and the second summation result; and can further indicate a comparison in values between the sum of the leaf values corresponding to the plurality of target leaf nodes and the preset threshold, where the sum of the leaf values corresponding to the plurality of target leaf nodes is the prediction result of the decision forest.

According to the data processing method provided in this implementation of the present specification, the second device can determine the target location identifier based on the parameter information of the decision tree; perform oblivious transfer with the first device by using the target location identifier as an input; and select a target leaf value ciphertext from leaf value ciphertexts that correspond to leaf nodes in the decision tree and that are input by the first device. As such, based on oblivious transfer, the first device and/or the second device can obtain a predication result of the decision forest or obtain a comparison result while the first device does not disclose the decision forest and the second device does not disclose service data. The comparison result is used to indicate a comparison in values between the predication result and the preset threshold.

Refer to FIG. 8. The present specification further provides an implementation of a data processing device. This implementation can be applied to a first device, where the first device provides a decision forest, and the decision forest includes at least one decision tree. The device includes the following unit: a sending unit 50, configured to send parameter information of the decision tree to a second device, where the parameter information includes a location identifier corresponding to a burst node, a splitting criterion corresponding to the burst node, and a location identifier corresponding to each leaf node, but does not include a leaf value corresponding to each leaf node.

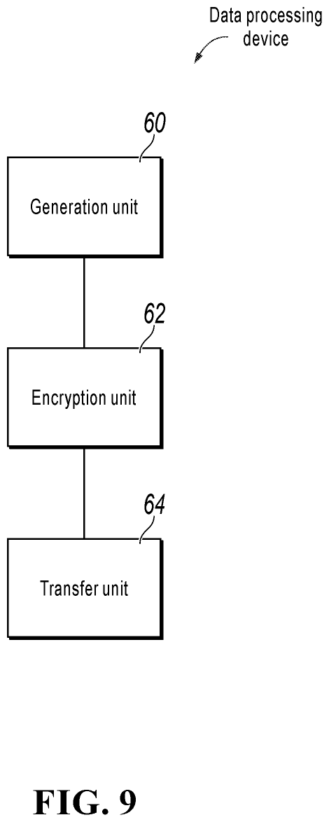

Refer to FIG. 9. The present specification further provides an implementation of a data processing device. This implementation can be applied to a first device, where the first device provides a decision forest, and the decision forest includes at least one decision tree. The device includes the following units: a generation unit 60, configured to generate a random number corresponding to the decision tree; an encryption unit 62, configured to encrypt leaf values corresponding to leaf nodes in the decision tree by using the random number, to obtain leaf value ciphertexts; and a transfer unit 64, configured to perform oblivious transfer with a second device by using the leaf values corresponding to the leaf nodes in the decision tree as an input.

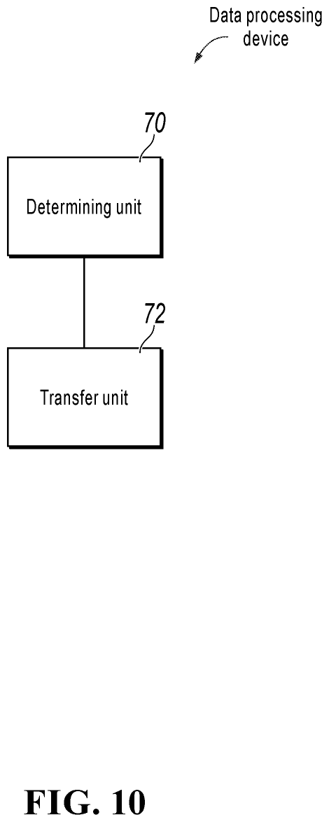

Refer to FIG. 10. The present specification further provides an implementation of a data processing device. This implementation can be applied to a second device, where the second device provides parameter information of a decision tree in a decision forest; the parameter information includes a location identifier corresponding to a burst node, a splitting criterion corresponding to the burst node, and a location identifier corresponding to each leaf node, but does not include a leaf value corresponding to each leaf node. The device includes the following units: a determining unit 70, configured to determine a target location identifier based on the parameter information of the decision tree in a decision forest, where a leaf node corresponding to the target location identifier matches service data; and a transfer unit 72, configured to perform oblivious transfer with the first device by using the target location identifier as an input; and select a target leaf value ciphertext from leaf value ciphertexts that correspond to leaf nodes in the decision tree and that are input by the first device.

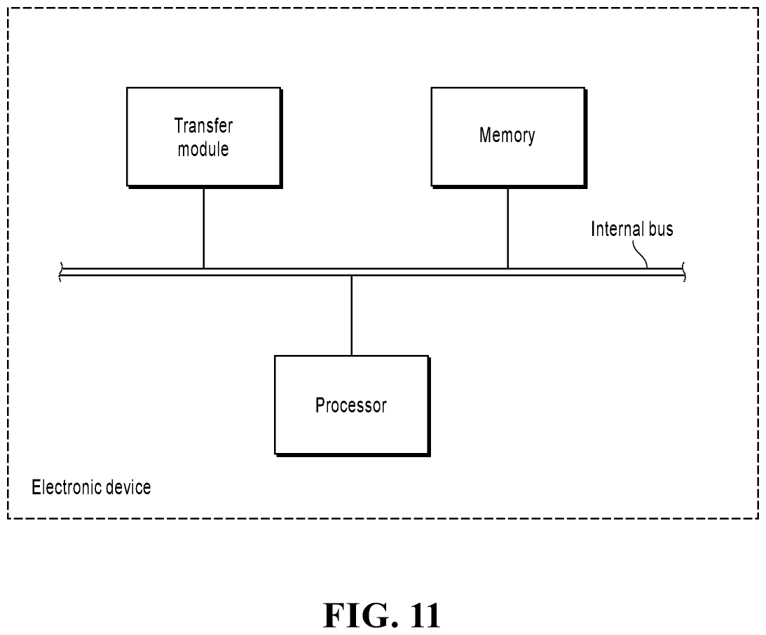

The following describes one implementation of an electronic device provided in the present specification. FIG. 11 is a schematic diagram illustrating a hardware structure of an electronic device provided in an implementation of the present specification. As shown in FIG. 11, the electronic device can include one or more processors (only one processor is shown), memories, and transfer modules. Certainly, a person of ordinary skill in the art should understand that the hardware structure shown in FIG. 11 is merely an example and does not constitute any limitation on the hardware structure of the electronic device. In practice, the electronic device can include more or fewer components than those shown in FIG. 11; or have a configuration different than that shown in FIG. 11.

The memory can include a high-speed random access memory; or can include a nonvolatile memory, such as one or more magnetic storage devices, a flash memory, or another nonvolatile solid-state memory. Certainly, the memory can alternatively include a remote network memory. The remote network memory can be connected to the electronic device through the Internet, an enterprise intranet, a local area network, a mobile communications network, etc. The memory can be configured to store program instructions or modules of application software, such as program instructions or modules of the implementation corresponding to FIG. 2 in the present specification, program instructions or modules of the implementation corresponding to FIG. 5, or program instructions or modules of the implementation corresponding to FIG. 6.

The processor can be implemented by using an appropriate method. For example, the processor can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. The processor can read and execute program instructions or modules in the memory.

The transfer module can be configured to transfer data through a network, for example, through the Internet, an enterprise intranet, a local area network, or a mobile communications network.

It is worthwhile to note that the implementations of the present specification are described in a progressive way. For same or similar parts of the implementations, mutual references can be made to the implementations. Each implementation focuses on a difference from the other implementations. Particularly, a device implementation and an electronic device implementation are basically similar to a data processing method implementation, and therefore are described briefly. For related parts, references can be made to related descriptions in the data processing method implementation.

In addition, it should be understood that, after reading the present specification, a person skilled in the art can freely combine some or all of the implementations in the present specification without creative efforts, and such combinations shall fall within the protection scope of the present specification.

In the 1990s, whether technology improvement is hardware improvement (for example, improvement of circuit structures, such as a diode, a transistor, or a switch) or software improvement (improvement of a method procedure) can be obviously distinguished. However, as technologies develop, the current improvement for many method procedures can be considered as a direct improvement of a hardware circuit structure. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, the programming is mostly implemented by modifying “logic compiler” software instead of manually making an integrated circuit chip. This is similar to a software compiler used for program development and compiling. However, original code before compiling is also written in a specific programming language, which is referred to as a hardware description language (HDL). There are many HDLs, such as an Advanced Boolean Expression Language (ABEL), an Altera Hardware Description Language (AHDL), Confluence, a Cornell University Programming Language (CUPL), HDCal, a Java Hardware Description Language (JHDL), Lava, Lola, MyHDL, PALASM, and a Ruby Hardware Description Language (RHDL). Currently, a Very-High-Speed Integrated Circuit Hardware Description Language (VHDL) and Verilog2 are most commonly used. A person skilled in the art should also understand that a hardware circuit that implements a logical method procedure can be readily obtained once the method procedure is logically programmed by using the several described hardware description languages and is programmed into an integrated circuit.

The system, device, module, or unit illustrated in the previous implementations can be implemented by using a computer chip or an entity, or can be implemented by using a product having a certain function. A typical implementation device is a computer. A specific form of the computer can be a personal computer, a laptop computer, a cellular phone, a camera phone, an intelligent phone, a personal digital assistant, a media player, a navigation device, an email transceiver device, a game console, a tablet computer, a wearable device, or any combination thereof.

It can be learned from descriptions of the implementations that a person skilled in the art can clearly understand that the present specification can be implemented by using software in addition to a necessary universal hardware platform. Based on such an understanding, the technical solutions in the present specification essentially or the part contributing to the existing technology can be implemented in a form of a software product. The software product can be stored in a storage medium, such as a ROM/RAM, a magnetic disk, or an optical disc, and includes several instructions for instructing a computer device (such as a personal computer, a server, or a network device) to perform the methods described in the implementations or in some parts of the implementations of the present specification.

The present specification can be used in many general-purpose or dedicated computer system environments or configurations, for example, a personal computer, a server computer, a handheld device, a portable device, a tablet device, a mobile communications terminal, a multiprocessor system, a microprocessor system, a programmable electronic device, a network PC, a small computer, a mainframe computer, and a distributed computing environment including any of the above systems or devices.

The present specification can be described in the general context of computer executable instructions executed by a computer, for example, a program module. Generally, the program module includes a routine, a program, an object, a component, a data structure, etc. executing a specific task or implementing a specific abstract data type. The present specification can also be practiced in distributed computing environments. In the distributed computing environments, tasks are performed by remote processing devices connected through a communications network. In a distributed computing environment, the program module can be located in both local and remote computer storage media including storage devices.

Although the present specification is described by using the implementations, a person of ordinary skill in the art knows that many modifications and variations of the present specification can be made without departing from the spirit of the present specification. It is expected that the claims include these modifications and variations without departing from the spirit of the present specification.

1. (canceled)

2. A computer-implemented method comprising:
generating a random number corresponding to a decision tree in a decision forest;
generating leaf value ciphertexts based on encrypting leaf values that correspond to leaf nodes in the decision tree using the random number; and
performing oblivious transfer with another device using the leaf value ciphertexts as an input.

3. The method of claim 2, wherein encrypting the leaf values comprises adding the random numbers and a leaf value corresponding to each leaf node in the decision tree.

4. The method of claim 2, wherein the decision forest comprises a plurality of decision trees, and wherein generating the random number comprises generating a respective random number for each decision tree in the decision forest.

5. The method of claim 2, wherein the a sum of random numbers corresponding to a plurality of decision trees comprises a predetermined value.

6. The method of claim 2, wherein the decision forest comprises a single decision tree only.

7. A computer-implemented system comprising:
one or more computers, and
one or more computer memory devices interoperably coupled with the one or more computers and having tangible, non-transitory, machine-readable media storing one or more instructions that, when executed by the one or more computers, perform operations comprising:
generating a random number corresponding to a decision tree in a decision forest;
generating leaf value ciphertexts based on encrypting leaf values that correspond to leaf nodes in the decision tree using the random number; and
performing oblivious transfer with another device using the leaf value ciphertexts as an input.

8. The system of claim 7, wherein encrypting the leaf values comprises adding the random numbers and a leaf value corresponding to each leaf node in the decision tree.

9. The system of claim 7, wherein the decision forest comprises a plurality of decision trees, and wherein generating the random number comprises generating a respective random number for each decision tree in the decision forest.

10. The system of claim 7, wherein the a sum of random numbers corresponding to a plurality of decision trees comprises a predetermined value.

11. The system of claim 7, wherein the decision forest comprises a single decision tree only.

12. A non-transitory, computer-readable medium storing one or more instructions executable by a computer system to perform operations comprising:
generating a random number corresponding to a decision tree in a decision forest;
generating leaf value ciphertexts based on encrypting leaf values that correspond to leaf nodes in the decision tree using the random number; and
performing oblivious transfer with another device using the leaf value ciphertexts as an input.

13. The medium of claim 12, wherein encrypting the leaf values comprises adding the random numbers and a leaf value corresponding to each leaf node in the decision tree.

14. The medium of claim 12, wherein the decision forest comprises a plurality of decision trees, and wherein generating the random number comprises generating a respective random number for each decision tree in the decision forest.

15. The medium of claim 12, wherein the a sum of random numbers corresponding to a plurality of decision trees comprises a predetermined value.

16. The medium of claim 12, wherein the decision forest comprises a single decision tree only.
